(19) United States
(12) Patent Application Publication
(10) Pub. No.: US 2017/0161974 A1
(43) Pub. Date: Jun. 8, 2017

(54) METHOD OF PREVENTING HACKING OF WIRELESS SIGNALS

(71) Applicants: HYUNDAI MOTOR COMPANY, Seoul (KR); KIA MOTORS CORPORATION, Seoul (KR)

(72) Inventors: Jong Ho KIM, Hwaseong-si (KR); Yong Seok JEONG, Yongin-si (KR); Jung Jun LEE, Seoul (KR); Jae Woong MIN, Seoul (KR)

(21) Appl. No.: 15/188,607

(22) Filed: Jun. 21, 2016

(30) Foreign Application Priority Data
Dec. 2, 2015 (KR) 10-2015-0170946

(51) Int. Cl. G07C 9/00

(52) U.S. Cl. CPC G07C 9/00007; G07C 9/00309; G07C 2009/00555; G07C 2009/00769

(57) ABSTRACT

A method of preventing hacking of wireless signals includes transmitting a low frequency (LF) signal from a vehicle to a smart key, deciding a strength of the received LF signal by the smart key, transmitting a radio frequency (RF) signal to the vehicle when the strength of the LF signal is decided and the LF signal is a signal satisfying a preset reference value, or a preset reference value range, of strength of an LF signal, and deciding a strength of the received RF signal by the vehicle.

### CROSS-REFERENCE TO RELATED APPLICATION

This application claims the benefit of priority to Korean Patent Application No. 10-2015-0170946, filed on Dec. 2, 2015 with the Korean Intellectual Property Office, the disclosure of which is incorporated herein in its entirety by reference.

### TECHNICAL FIELD

The present disclosure relates to a method of preventing hacking of wireless signals, and more particularly, to a technology of preventing hacking of wireless signals transmitted and received between a vehicle and a smart key.

### BACKGROUND

Generally, in the case in which a user is to remotely control a target device, the user may manipulate the control target device by a separate wireless adjusting apparatus using a communication module provided in the control target device. For example, in the case in which the control target device is a vehicle, the user manipulates the vehicle by a separate wireless adjusting apparatus using a communication module provided in the vehicle at the time of remotely controlling the vehicle, thereby making it possible to lock or unlock a door of the vehicle, and/or perform additional features.

As described above, in order to remotely control the control target device, the user may carry the wireless adjusting apparatus for a remote control and manipulate the wireless adjusting apparatus for a remote control within a distance at which communication with the control target device is possible, which may be inconvenient.

In addition, since many users carry a mobile phone, it may be inconvenient in terms of the need of the user to draw out and manipulate the wireless adjusting apparatus for a remote control while carrying the wireless adjusting apparatus for a remote control in addition to the mobile phone.

In consideration of this problem, there is a vehicle remote control apparatus using Bluetooth capable of controlling locking and unlocking of the door of the vehicle or controlling starting of the vehicle using a wireless adjusting apparatus in which the Bluetooth is embedded.

However, the vehicle remote control apparatus using a Bluetooth may be weak in terms of security, such that it may be problematic when the vehicle is stolen, and when the door of the vehicle is opened simply using a smart key, it is not easy to identify a driver.

### SUMMARY

The present disclosure has been made to solve the above-mentioned problems occurring in the prior art while advantages achieved by the prior art are maintained intact.

An aspect of the present disclosure provides a method of preventing hacking of wireless signals capable of preventing theft of a vehicle by using a low frequency (LF) signal and a radio frequency (RF) signal that become tuning references between the vehicle and a smart key and comparing a strength of the LF signal received in the smart key and a strength of the RF signal received in the vehicle with the respective set reference values to doubly decide whether the RF signal and the LF signal are normal signals.

According to an exemplary embodiment of the present disclosure, a method of preventing hacking of wireless signals may include: transmitting an LF signal from a vehicle to a smart key; deciding a strength of the received LF signal by the smart key; transmitting an RF signal to the vehicle when the strength of the LF signal is decided and the LF signal is a signal satisfying a preset reference value, or a preset reference value range, of strength of an LF signal; and deciding a strength of the received RF signal by the vehicle.

The method of preventing hacking of wireless signals may further include, between the step of transmitting the LF signal from the vehicle to the smart key and the step of deciding the strength of the received LF signal by the smart key: amplifying the transmitted LF signal using a first repeater to be modulated to an RF signal; transmitting the modulated RF signal to a second repeater by the first repeater; again demodulating the modulated RF signal into an LF signal by the second repeater; and transmitting the demodulated LF signal to the smart key by the second repeater.

The step of deciding the strength of the received LF signal by the smart key may include allowing the RF signal not to be transmitted in the case in which the strength of the LF signal is out of the preset reference value, or preset reference value range, of the strength of the LF signal.

The step of deciding the strength of the received LF signal by the smart key may include transmitting the RF signal in the case in which the strength of the LF signal is not out of the preset reference value, or preset reference value range, of the strength of the LF signal.

The method of preventing hacking of wireless signals may further include, between the step of transmitting the RF signal to the vehicle and the step of deciding the strength of the received RF signal by the vehicle: transmitting the RF signal to an RF amplifying apparatus by the smart key; amplifying the transmitted RF signal using the RF amplifying apparatus; and transmitting the amplified RF signal to the vehicle.

The step of deciding the strength of the received RF signal by the vehicle may include: deciding that the RF signal is a wireless signal error; and performing a control so that opening/closing of a door of the vehicle or starting of the vehicle is not operated, in the case in which the strength of the RF signal is out of a preset reference value, or a preset reference value range, of strength of an RF signal.

The method of preventing hacking of wireless signals may further include, after the step of performing the control so that opening/closing of the door of the vehicle or starting of the vehicle is not operated: setting the vehicle to an emergency situation mode and urgently braking an engine of the vehicle using Telematics; and providing a warning sound or a warning phrase to a driver by the vehicle.

The step of deciding the strength of the received RF signal by the vehicle may include: deciding that the RF signal is a normal wireless signal; and performing a control so that opening/closing of a door of the vehicle or starting of the vehicle is normally operated, in the case in which the strength of the RF signal is not out of a preset reference value, or a preset reference value range, of strength of an RF signal.

### BRIEF DESCRIPTION OF THE DRAWINGS

The above and other objects, features and advantages of the present disclosure will be more apparent from the following detailed description taken in conjunction with the accompanying drawings.

FIG. 1 is a view for describing a method of transmitting and receiving wireless signals between a vehicle and a smart key according to an exemplary embodiment of the present disclosure.

FIG. 2 is a flow chart for describing a method of preventing hacking of wireless signals according to an exemplary embodiment of the present disclosure.

FIG. 3 is a flow chart for describing a method of preventing hacking of wireless signals according to another exemplary embodiment of the present disclosure.

### DETAILED DESCRIPTION

Advantages and features of the present disclosure and methods for accomplishing them will become apparent from exemplary embodiments described below in detail with reference to the accompanying drawings. However, the present disclosure is not limited to exemplary embodiments described herein, but may be implemented in other forms. These exemplary embodiments are provided in order to describe the present disclosure in detail so that those skilled in the art to which the present disclosure pertains may easily practice the spirit of the present disclosure.

In the accompanying drawings, exemplary embodiments of the present disclosure are not limited to illustrated specific forms, but may be exaggerated for the purpose of clarity. Although specific terms have been used in the present specification, they are used in order to describe the present disclose and are not used in order to limit the meaning or the scope of the present disclosure, which is disclosed in the appended claims.

In the present specification, a term ‘and/or’ is used as the meaning including at least one of components arranged before and after the term. In addition, terms ‘connected/coupled’ are used such that any component is directly connected to another component or is indirectly connected to another component through the other component. Unless explicitly described to the contrary, a singular form includes a plural form in the present specification. In addition, components, steps, operations, and elements mentioned by terms ‘include’ or ‘including’ used in the present specification mean the existence or addition of one or more other components, steps, operations, and elements.

Hereinafter, an exemplary embodiment of the present disclosure will be described in detail with reference to the accompanying drawings.

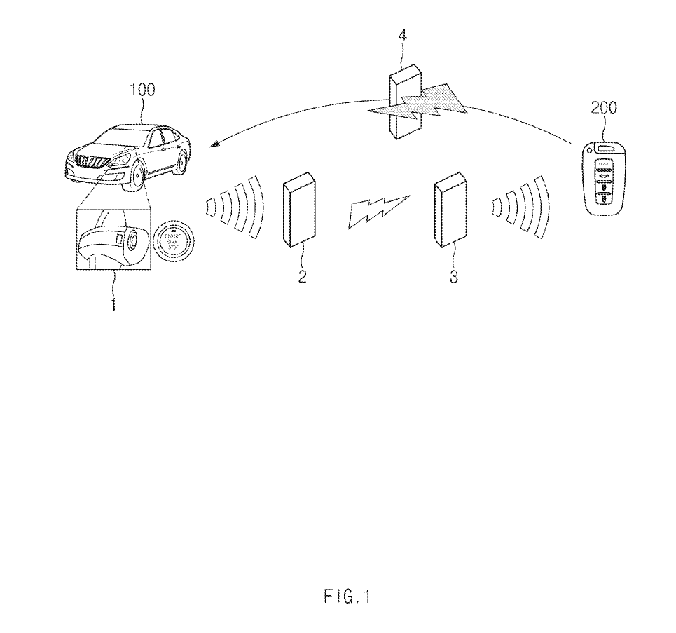

FIG. 1 is a view for describing a method of transmitting and receiving wireless signals between a vehicle and a smart key according to an exemplary embodiment of the present disclosure.

Referring to FIG. 1, when a driver presses a start button 1 of a vehicle 100 or presses a door opening/closing switch of the vehicle, a low frequency (LF) signal may be transmitted from the vehicle 100 to a first repeater 2.

In detail, a head unit or a smart unit provided in the vehicle 100 may recognize an operation of the start button 1 or the door opening/closing switch of the vehicle and transmit the LF signal. The head unit or the smart unit may be a system concerted with start, and may be a system including an immobilizer function to prevent theft of the vehicle.

Next, the first repeater 2 may modulate the LF signal and transmit the modulated signal to a second repeater 3.

Next, the second repeater 3 again may demodulate the received signal into an LF signal and transmit the LF signal to a smart key 200, and the smart key 200 may decide a strength of the LF signal.

In detail, the smart key 200 may not recognize that the LF signal is a normal signal and may not normally transmit a radio frequency (RF) signal (an RF response signal) to the vehicle 100 in the case in which it decides the strength of the received LF signal and the strength of the received LF signal does not satisfy a preset reference value, or reference value range, of a strength of an LF signal or is out of a range of the reference value.

However, the smart key 200 may recognize that the LF signal is the normal signal transmitted from the vehicle 100 and may transmit the RF signal (the RF response signal) to an RF amplifying apparatus 4 in the case in which it decides the strength of the received LF signal and the strength of the received LF signal satisfies the preset reference value of the strength of the LF signal or is not out of the range of the reference value.

Here, the reference value, or reference value range, of the strength of the LF signal may be adjusted depending on characteristics of the vehicle. As used in this application, a reference value or a preset reference value may also include a preset reference value range.

The reference value of the strength of the LF signal may be set as described below. The reference value may be set by allowing the smart key 200 to contact an LF antenna and measuring the strength of the LF signal that the smart key 200 may receive from the LF antenna for a predetermined time. The reference value of the strength of the LF signal may be set to a range in 100%±10%, and may also be adjusted to various ranges.

For example, when the reference value of the strength of the LF signal is set to 100%, the smart key 200 does not recognize that the LF signal is the normal signal and does not normally transmit the RF signal (the RF response signal) to the vehicle 100 in the case in which the strength of the received LF signal is out of the range of the preset reference value of the strength of the LF signal.

In addition, the smart key 200 may recognize that the LF signal is the normal signal transmitted from the vehicle 100 and may normally transmit the RF signal (the RF response signal) to the RF amplifying apparatus 4 in the case in which the strength of the received LF signal is not out of the range of the preset reference value of the strength of the LF signal.

Next, the transmitted RF signal may be amplified using the RF amplifying apparatus 4, and the vehicle 100 receiving the amplified RF signal may decide a strength of the RF signal.

In detail, the vehicle 100 may not recognize that the RF signal is a normal signal (decides that the RF signal is a wireless signal error) and may not allow opening/closing of a door of the vehicle 100 or starting of the vehicle 100 in the case in which the vehicle 100 decides the strength of the received RF signal and the strength of the received RF signal is out of a range of a preset reference value of a strength of an RF signal.

However, the vehicle 100 may decide that the RF signal is the normal signal and may perform a control so that opening/closing of the door of the vehicle 100, starting of the vehicle 100, or the like, is normally operated in the case in which the vehicle 100 decides the strength of the received RF signal and the strength of the received RF signal is not out of the range of the preset reference value of the strength of the RF signal.

The reference value of the strength of the RF signal may be adjusted depending on characteristics of the vehicle.

The reference value of the strength of the RF signal may be set as described below. The reference value may be set by allowing the vehicle 100 to contact an RF antenna and measuring the strength of the RF signal that the vehicle 100 receives from the RF antenna for a predetermined time. The reference value of the strength of the RF signal may be set to a range of 100%±10%, and may also be adjusted to various ranges.

For example, when the reference value of the strength of the RF signal is set to 100%±10%, the vehicle 100 may not recognize that the RF signal is the normal signal in the case in which the strength of the received RF signal is out of the preset reference value of the strength of the RF signal, and may recognize that the RF signal is the normal signal and thus may perform a control so that opening/closing of the door of the vehicle 100, starting of the vehicle 100, or the like, is normally operated in the case in which the strength of the received RF signal is not out of the preset reference value, or preset reference value range, of the strength of the RF signal.

That is, the present disclosure may be a method of coping with hacking of wireless signals including a method in which the smart key 200 receives the LF signal amplified and transmitted from the vehicle 100 and decides whether or not the LF signal is the normal signal and a method in which the vehicle 100 receives the RF signal (the amplified signal or the response signal) transmitted by the smart key 200 and decides whether or not the RF signal is the normal signal.

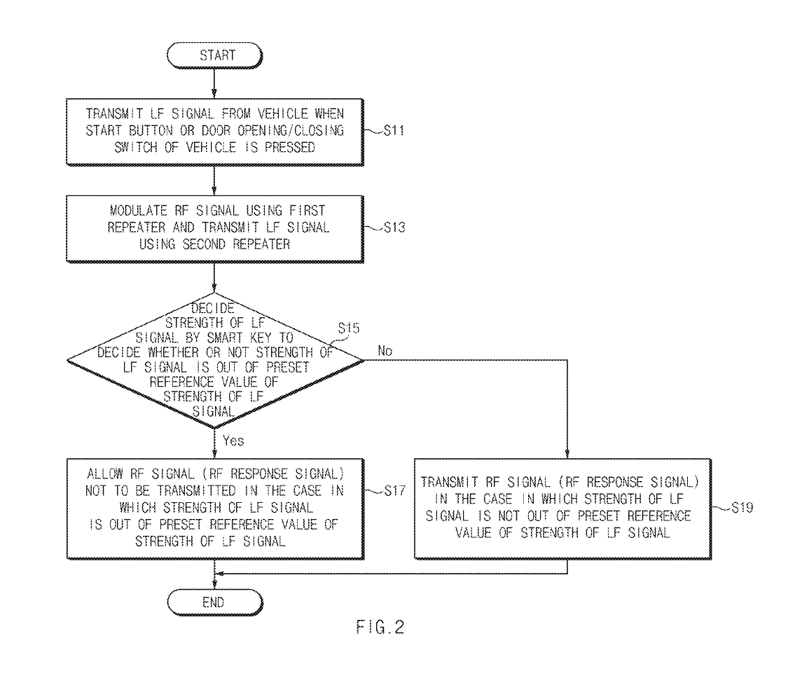

FIG. 2 is a flow chart for describing a method of preventing hacking of wireless signals according to an exemplary embodiment of the present disclosure.

Referring to FIG. 2, when a driver or a user presses a start button or presses a door opening/closing switch of the vehicle in order to enter the vehicle, the LF signal may be transmitted from the vehicle to the smart key (S11).

Next, the transmitted LF signal may be amplified using the first repeater to be modulated into the RF signal, the first repeater may transmit the modulated RF signal to the second repeater, and the second repeater again may demodulate the modulated RF signal into the LF signal (S13).

Next, the second repeater may transmit the demodulated LF signal to the smart key, and the smart key may decide the strength of the LF signal (S15).

Here, the smart key may not transmit the RF signal (the RF response signal) (S17) in the case in which the smart key decides the strength of the received LF signal and the strength of the received LF signal is out of the preset reference value, or range, of the strength of the LF signal (does not satisfy the reference value).

However, the smart key may transmit the RF signal (the RF response signal) (S19) in the case in which the smart key decides the strength of the received LF signal and the strength of the received LF signal is not out of the preset reference value, or range, of the strength of the LF signal (satisfies the reference value).

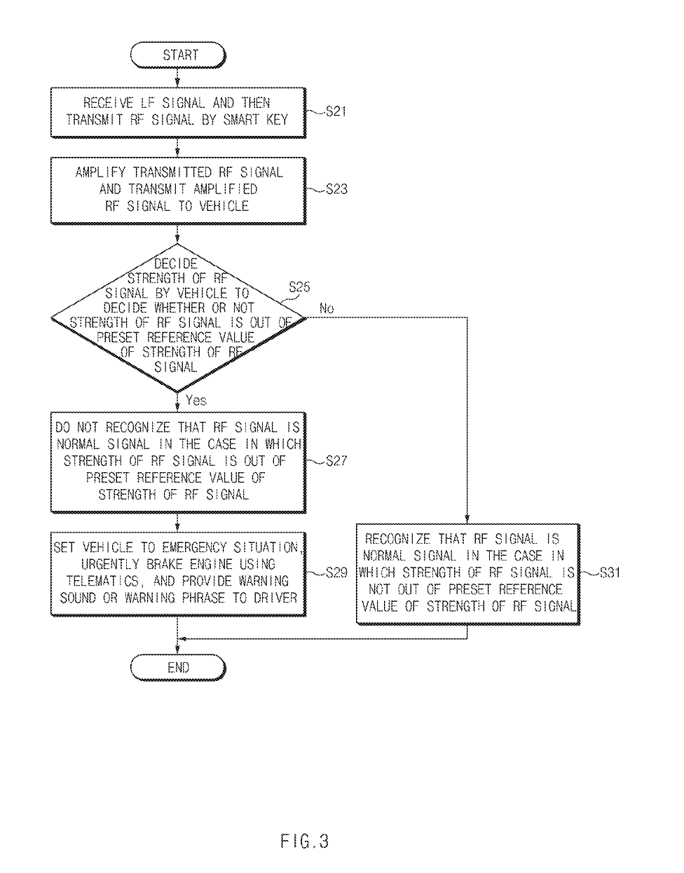

FIG. 3 is a flow chart for describing a method of preventing hacking of wireless signals according to another exemplary embodiment of the present disclosure.

Referring to FIG. 3, the smart key may receive the LF signal, and then may transmit the RF signal (the RF response signal) to the RF amplifying apparatus (S21).

Next, the transmitted RF signal may be amplified using the RF amplifying apparatus, and the RF amplifying apparatus may transmit the amplified RF signal to the vehicle (S23).

Next, the vehicle may decide the strength of the RF signal (S25).

Here, the vehicle may not recognize that the RF signal is the normal signal (decides that the RF signal is the wireless signal error) and may perform a control so that opening/closing of the door of the vehicle, starting of the vehicle, or the like, is not operated (S27) in the case in which the vehicle decides the strength of the received RF signal and the strength of the received RF signal is out of the preset reference value, or preset reference value range, of the strength of the RF signal (does not satisfy the reference value).

Next, after the vehicle performs a control so that opening/closing of the door, starting of the vehicle, or the like, is not operated, the vehicle may be set to an emergency situation mode, an engine of the vehicle may be urgently braked through Telematics, and a warning sound or a warning phrase may be provided to the driver (S29).

However, the vehicle may decide that the RF signal is the normal wireless signal and may perform a control so that opening/closing of the door of the vehicle, starting of the vehicle, or the like, is normally operated (S31) in the case in which the vehicle decides the strength of the received RF signal and the strength of the received RF signal is not out of the preset reference value, or preset reference value range, of the strength of the RF signal (satisfies the reference value).

As described above, according to an exemplary embodiment of the present disclosure, the wireless signals transmitted and received between the vehicle and the smart key may be doubly controlled, thereby making it possible to prevent theft of the vehicle.

In addition, according to an exemplary embodiment of the present disclosure, an additional cost for preventing hacking of the wireless signals between the vehicle and the smart key is not generated, and the theft of the vehicle is prevented, thereby increasing demand for the vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A method of preventing hacking of wireless signals, comprising:
transmitting a low frequency (LF) signal from a vehicle to a smart key;
deciding a strength of the received LF signal by the smart key;
transmitting a radio frequency (RF) signal to the vehicle when the strength of the LF signal is decided and the LF signal is a signal satisfying a preset reference value, or preset reference value range, of strength of an LF signal;
deciding a strength of the received RF signal by the vehicle; and
wherein the step of deciding the strength of the received LF signal by the smart key includes allowing the RF signal not to be transmitted in the case in which the strength of the LF signal is out of the present reference value, or preset reference value range, of the strength of the LF signal and transmitting the RF signal in the case in which the strength of the LF signal is not out of the preset reference value, or preset reference value range, of the strength of the LF signal.

2. The method of preventing hacking of wireless signals according to claim 1, further comprising, between the step of transmitting of the LF signal from the vehicle to the smart key and the step of deciding of the strength of the received LF signal by the smart key:
amplifying the transmitted LF signal using a first repeater to be modulated to an RF signal;
transmitting the modulated RF signal to a second repeater by the first repeater;
again demodulating the modulated RF signal into an LF signal by the second repeater; and
transmitting the demodulated LF signal to the smart key by the second repeater.

3. (canceled)

4. (canceled)

5. The method of preventing hacking of wireless signals according to claim 1, further comprising, between the step of transmitting of the RF signal to the vehicle and the step of deciding the strength of the received RF signal by the vehicle:
transmitting the RF signal to an RF amplifying apparatus by the smart key;
amplifying the transmitted RF signal using the RF amplifying apparatus; and
transmitting the amplified RF signal to the vehicle.

6. The method of preventing hacking of wireless signals according to claim 1, wherein the step of deciding the strength of the received RF signal by the vehicle includes: deciding that the RF signal is a wireless signal error; and performing a control so that opening/closing of a door of the vehicle or starting of the vehicle is not operated in the case in which the strength of the RF signal is out of a preset reference value, or a preset reference value range, of strength of an RF signal.

7. The method of preventing hacking of wireless signals according to claim 6, further comprising, after the step of performing the control so that the opening/closing of the door of the vehicle or the starting of the vehicle is not operated:
setting the vehicle to an emergency situation mode and urgently braking an engine of the vehicle using Telematics; and
providing a warning sound or a warning phrase to a driver by the vehicle.

8. The method of preventing hacking of wireless signals according to claim 1, wherein the step of deciding the strength of the received RF signal by the vehicle includes:
deciding that the RF signal is a normal wireless signal; and performing a control so that opening/closing of a door of the vehicle or starting of the vehicle is normally operated, in the case in which the strength of the RF signal is not out of a preset reference value, or a preset reference value range, of strength of an RF signal.
